(19) United States
(12) Patent Application Publication
(10) Pub. No.: US 2015/0260385 A1
(43) Pub. Date: Sep. 17, 2015

(54) Landscape Lighting with Remote Control Feature

(71) Applicant: Alan L. Brynjolfsson, Tampa, FL (US)

(72) Inventor: Alan L. Brynjolfsson, Tampa, FL (US)

(21) Appl. No.: 14/643,171

(22) Filed: Mar. 10, 2015

Related U.S. Application Data
(60) Provisional application No. 61/951,848, filed on Mar. 12, 2014.

(51) Int. Cl. F21V 23/04; H05B 33/08; F21V 23/00; F21V 5/04; F21S 9/03

(52) U.S. Cl. CPC F21V 23/045; F21V 5/048; F21S 9/037; F21V 23/009; H05B 33/0854; F21Y 2101/02

(57) ABSTRACT

A landscape lighting fixture for outdoor illumination comprising a fixture body, a control board, a protective tens, and a guard. The fixture body, guard, and protective lens form a housing for the control board, which includes a light source and a sensor chip. A remote control may be used to generate a control signal that is received by the sensor chip to control the light source. The light source may be a plurality of light-emitting diodes (LEDs), and an optical assembly may be used to diffuse the light from the plurality of LEDs such that they appear to be one light.

### PRIORITY CLAIM

This application claims the benefit of provisional application Ser. No. 61/951,848, filed Mar. 12, 2014, which is relied upon and incorporated herein by reference for all purposes.

### FIELD OF THE INVENTION

The present invention relates generally to the art of landscape lighting systems.

### BACKGROUND

Outdoor landscape lighting systems are commonly used in both commercial and residential settings for the illumination of structures, walkways, trees, shrubbery, etc. Although there are many reasons for outdoor illumination, the primary purposes are safety and aesthetics. Landscape lighting can facilitate the safety of those on the property by illuminating safe walkways and directing guests. Lighting can also be useful in pointing out potential obstacles, such as steps or uneven walking surfaces. Landscape lighting can improve the aesthetics of an area by highlighting its attractive features, such as architectural structures, trees, shrubs, and landscape designs. This also distracts guest from less attractive features of the property by selectively focusing their attention.

Common outdoor landscape lighting systems have three primary components: a power source, electrical wiring, and lighting fixtures. Lighting fixtures are usually placed where desired throughout the outdoor landscape and connected in parallel to the power source.

The power source may be a multi-tap transformer that is mounted in a box in a garage or utility closet. The multi-tap transformer plugs into a standard 120 VAC outlet and provides outputs at multiple voltages. For example, a common multi-tap transformer has AC outputs at 12V, 13V, 14V, and 15 V, where the higher voltages are often used to overcome voltage loss from high wattage loads or long cable runs. The transformer box may also have control circuitry and be used as a control panel for collectively controlling the lighting fixtures throughout the landscape. For example, the box can include a timer that turns all of the lights on or off at specified intervals, or a control for collectively brightening or dimming all the lights in the system.

In order to improve functionality and versatility, it is desirable to have an outdoor landscape lighting system where each of the lighting fixtures are individually dimmable and controllable.

### SUMMARY

Example embodiments of the present invention recognize and address considerations of prior art constructions and methods.

One aspect of the present invention provides a landscape lighting fixture for outdoor illumination. The landscape lighting fixture comprises a fixture body, a control board including a light source and a sensor chip, a protective lens, and a guard. The fixture body, the guard, and the protective lens form a housing for the control board, and the light source is controlled by a control signal received by the sensor chip.

Some example embodiments of the landscape lighting fixture may comprise a plurality of light-emitting diodes (LEDs), for example at least six LEDs. The landscape lighting fixture may further comprise a handheld remote which may send the control signal to the sensor chip using optical communication. The fixture body and the guard may be constructed with opaque material that does not transmit optical communications from the handheld remote. However, the fixture body may also comprise a transparent window through which the control signal may be transmitted to the sensor chip.

In some embodiments, the landscape lighting fixture may comprise an optical assembly juxtaposed to the control board for diffusing the light source. The landscape lighting fixture may also comprise a battery and a solar panel, wherein the solar panel generates electrical energy which is stored in the battery and is used to operate the landscape lighting fixture.

According to another example embodiment, a method for controlling a landscape lighting fixture may be provided. The method may comprise the steps of receiving an infrared control signal from a remote through a protective lens of the lighting fixture and using control circuitry to operate a plurality of light-emitting diodes (LEDs) in accordance with the infrared control signal. The method may further comprise the step of transmitting light from the plurality of LEDs through an optical assembly such that the lights appear to be one light source.

In accordance with some example embodiments, an infrared remote may send a control signal in the infrared spectrum which will not travel through the fixture body or guard. However, the infrared signal can be transmitted through the lens and optical assembly to the infrared sensor chip. Because the infrared remote can communicate with the infrared sensor only by a signal directed through a transmitting portion of the fixture, a user can control each lighting fixture in a lighting system independently of all others, without inadvertently controlling other fixtures.

Independent control of lighting fixtures allows the user to customize the landscape lighting according to the then-existing conditions of the landscape for improved safety and aesthetics. Unlike prior art systems, which allow for dimming or brightening of all lights collectively, the lighting fixtures of the present invention allow for independent control of every light in a system.

Those skilled in the art will appreciate the scope of the present invention and realize additional aspects thereof after reading the following detailed description of example embodiments in association with the accompanying drawing figures.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 shows a perspective view of an assembled lighting fixture according to an example embodiment of the present invention;

FIG. 2 shows an exploded view of the lighting fixture of FIG. 1 in accordance a with an example embodiment;

FIG. 3 shows a remote control device for individual control and dimming of a lighting fixture in accordance with an example embodiment;

FIG. 4 shows a control board that may be utilized in the lighting fixture of FIG. 1;

FIG. 5A shows a control board and optical assembly prior to attachment in accordance with an example embodiment;

FIG. 5B shows the control board after the optical assembly has been attached in accordance with an example embodiment;

FIG. 6 shows how the remote control device might use optical communications to control a landscape lighting fixture in accordance with an example embodiment; and

FIG. 7 is a block diagram showing interconnection of circuit components in accordance with a preferred embodiment.

Repeat use of reference characters in the present specification and drawings is intended to represent same or analogous features or elements of the invention.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations.

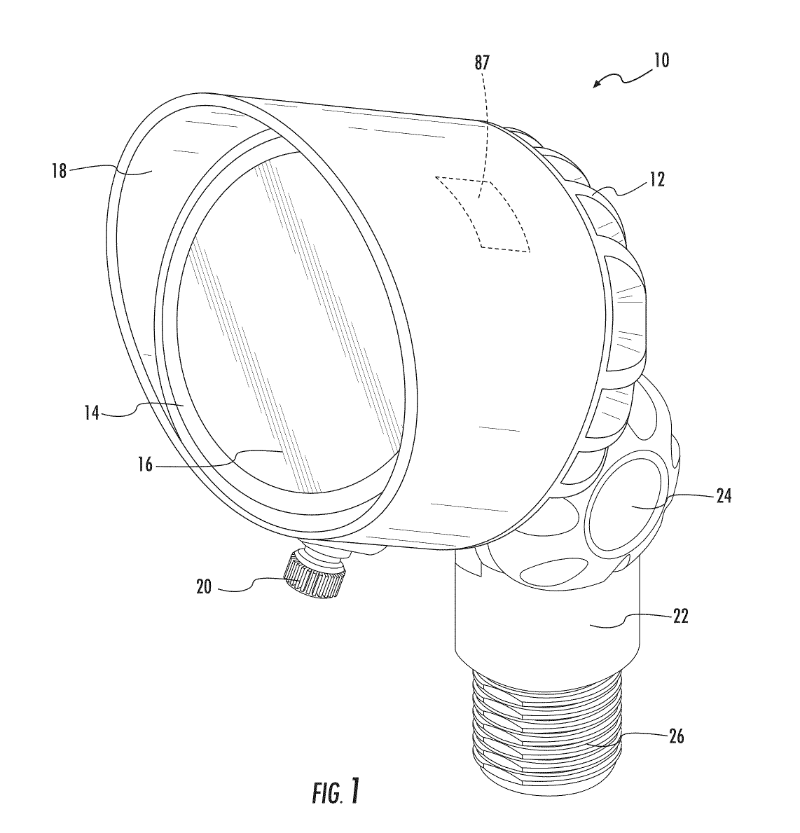

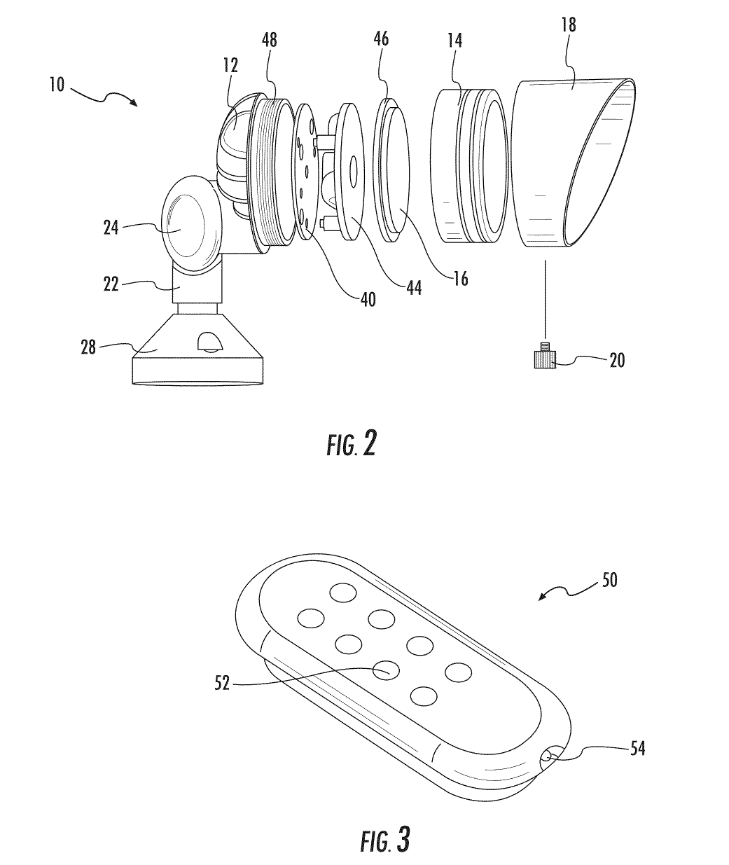

FIG. 1 shows a perspective view of an assembled lighting fixture 10 according to an example embodiment of the present invention. In the example embodiment, the fixture body 12 may provide a housing for some or all of the internal electronic components of the lighting fixture 10. For example, the control board, lighting elements, mounting structure, electrical wiring, etc. may be placed inside the fixture body 12 and may be enclosed therein by a guard 14 and lens 16. A cowl 18 may be placed over the guard 14 for directing light and may be secured in place by a retention screw 20. The fixture body 12 may be pivotally connected to a base extension 22 by swivel 24. In this regard, the fixture body 12 may be rotated about the axis of swivel 24, thus allowing the lighting fixture 10 to be pivoted, for example, between a horizontal orientation and a vertical orientation. The distal end of the base extension 22 may have a threaded portion 26 which may be used to connect the lighting fixture 10 to the fixture base 28 (see FIG. 2) or another suitable support structure.

FIG. 2 shows an exploded view diagram of the lighting fixture 10 of FIG. 1. In a preferred embodiment, the lighting fixture 10 receives power in the same manner as prior art systems—i.e., by direct electrical wiring from a transformer or from another lighting fixture connected in parallel. In an example embodiment, the fixture base 28, base extension 22, and swivel 24 may be hollow to provide a path for feeding the electrical wires into the back of the fixture body 12. The electrical wiring may then be connected to the control board 40, for example, by connecting the wires to power receptacle 42 (see FIG. 4). The control board 40 may be housed in the fixture body 12 and contains the light sources, control circuitry, sensors, and other electronic components needed to operate the lighting fixture 10. In one example, the lighting fixture operates nominally at 12 VAC, but the input voltage may vary from 9 VAC to 15 VAC.

Although the illustrated embodiment is powered by mains electricity through direct electrical wiring, one skilled in the art will appreciate that other means for powering the lighting fixture 10 are within the scope of the invention. For example, the lighting fixture may be solar-powered, relying on solar energy to charge an integrated energy storage device. In this regard, an integrated or standalone solar panel may be electrically connected to a battery located in the lighting fixture. The solar panel could charge the battery during the day, and the battery could power the lighting fixture at night. Other means for powering the lighting fixture are also contemplated.

In addition to housing the control board 40, the fixture body 12 houses an optical assembly 44, the operation of which will be discussed in more detail below. The optical assembly 44 and control board 40 are placed inside the fixture body 12 and covered by a guard 14 with a protective lens 16. The protective lens 16 is preferably fixed in the guard 14 such as by placing a bead of adhesive around flange 46 and securing it to a mating surface inside the guard 14. The resulting assembly is then fixed to the fixture body 12. In the illustrated embodiment, for example, the guard 14 may have internal threads which mate with external threads 48 on fixture body 12. The resulting assembly is watertight and ready to be installed for outdoor use. Finally, a cowl 18 for directing light can be slipped over the guard 14 and secured (e.g., by retention screw 20).

The fixture body 12 and guard 14 may be constructed of steel, plastic, or any other rigid or semi-rigid material sufficient to house and support the control board 40 and its components. The protective lens 16 may be formed from plastic, glass, or any other suitably rigid material that is light transmissive (and also allows the control signals to pass through) while providing sufficient protection to the internal components of the lighting fixture 10.

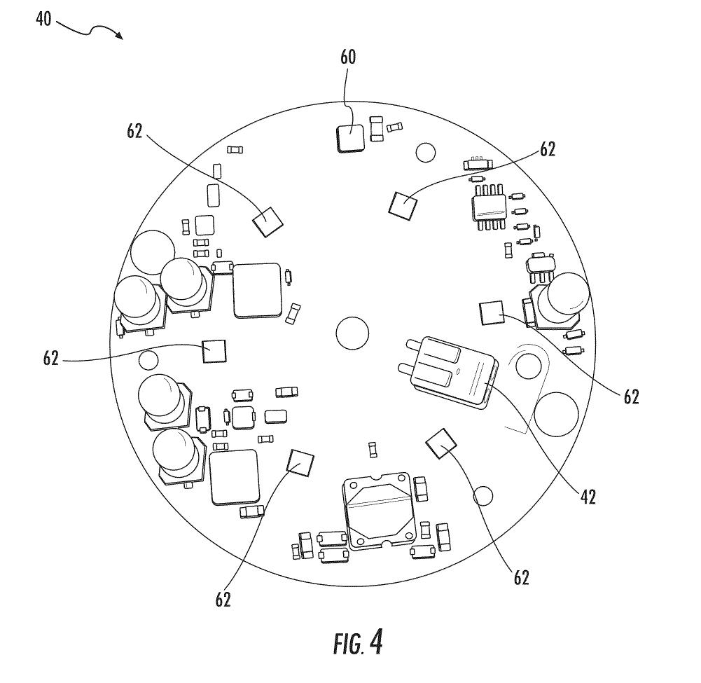

As will be described in more detail below, the lighting fixture 10 can be controlled by a suitable wireless remote control device, such as an optical (e.g., infrared) remote. FIG. 3 shows a perspective view of an infrared remote control 50 which may be used to control the lighting fixture 10. The remote control 50 is a small handheld device having a plurality of buttons 52 corresponding to different functions. For example, the buttons may correspond to “off” and a plurality of lighting intensity levels, respectively. At one or more locations on the remote control 50 is an infrared emitter 54 which is used to broadcast an infrared signal in accordance with operator input. In addition, the remote control 50 is preferably configurable to control multiple lighting fixtures within a landscape lighting system in this regard, a single remote control 50 may be capable of controlling all the outdoor lighting fixtures at a particular residential or commercial location one at a time. For example, the homeowner may walk around the property and individually set the intensity of illumination at each fixture.

Referring now specifically to FIG. 4, the control board 40 houses the electronics for operating the lighting fixture 10. The control board 40 includes an infrared sensor 60 for receiving an infrared control signal from the remote control 50. Typically, the infrared sensor 60 will be in the form of a chip mounted to the surface of the control board 40. The control board 40 may also include a light source comprising a plurality of light-emitting diodes 62 (LEDs). In the illustrated embodiment shown in FIG. 4, the control board 40 comprises six LEDs 62. One skilled in the art will understand, however, that a different number or type of light source may be used within the scope of the invention. The LEDs 62 are preferably mounted to the control board as shown in FIG. 4 and are controlled by the remote control 50. For example, the LEDs 62 may be turned on or off, may be brightened or dimmed, or may be otherwise adjusted, in response to a signal received by the infrared sensor 60.

One skilled in the art will recognize that the control board 40 may also include various standard electrical circuits. For example, the control board 40 may contain power supply circuitry that converts the AC voltage from the transformer to a DC voltage suitable for the light source. In addition, the control board 40 may include control circuitry that is in electrical communication with the LEDs 62 and the infrared sensor 60.

In the illustrated embodiment, the control board 40 comprises control circuitry, various electrical circuits, an infrared sensor 60, and a plurality of LEDs 62 as discrete components interconnected on a printed circuit board (PCB). However, this configuration is included for the purposes of explanation, and is not meant to be limiting. One skilled in the art will appreciate that there are other means for establishing electrical communication between the various system components. For example, the control board 40 may be a series of interconnected printed circuit boards, an integrated circuit, or may be physically embodied in any other manner sufficient to house the electronic components. Alternatively, the control board may be a collection of discrete electronic components mounted within the fixture body 12 and interconnected with electrical wires.

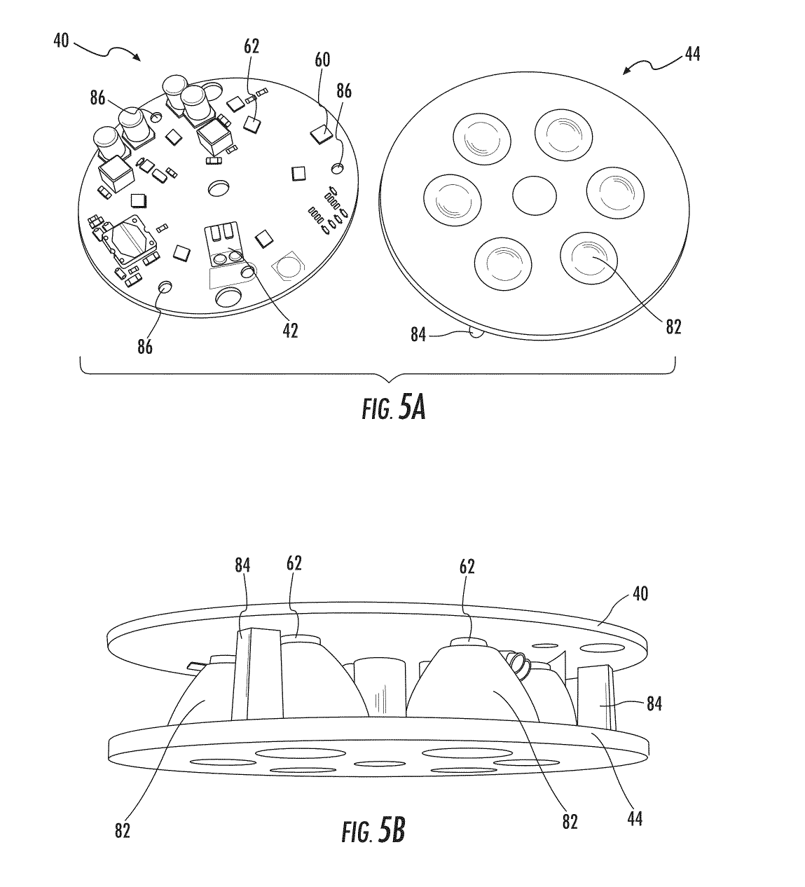

Referring now to FIGS. 5A and 5B, an optical assembly 44 is preferably placed on top of the control board for the purpose of diffusing, focusing, or directing the light emitted from the respective LEDs 62 such that the light exiting the lighting fixture 10 appears as one large light instead of multiple small lights. FIG. 5A shows the optical assembly 44 prior to mounting on the control board 40 and FIG. 5B shows the optical assembly 44 when mounted to the control board 40. In the illustrated embodiment, the optical assembly 44 comprises six light diffusing optical dimples 82 that are oriented on a circular support structure and correspond with the six LEDs 62 of the lighting fixture 10. Each optical dimple 82 may be, for example, a cone-shaped, translucent piece of plastic mounted on a translucent support plate. It can be seen that each of the six light diffusing optical dimples 82 are oriented such that they are situated over the top of each of the six LEDs 62, respectively. In the illustrated embodiment, this orientation is achieved through the use of two or more positioning arms 84 that extend from the optical assembly 44 and are inserted through corresponding mounting holes 86 in the control board 40. One skilled in the art will appreciate that other optical assemblies may be used which have different constructions or configurations, or which may be made of different materials. For example, in some cases, a frosted plastic disk may be an effective optical assembly 44 for a lighting fixture.

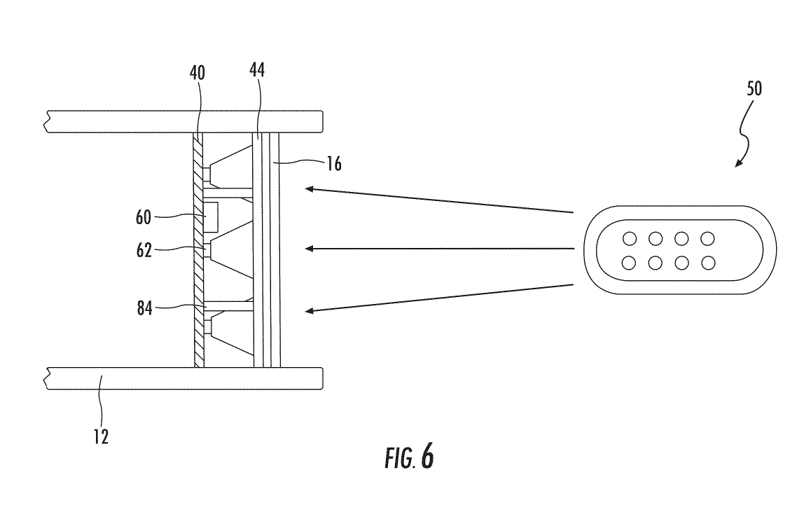

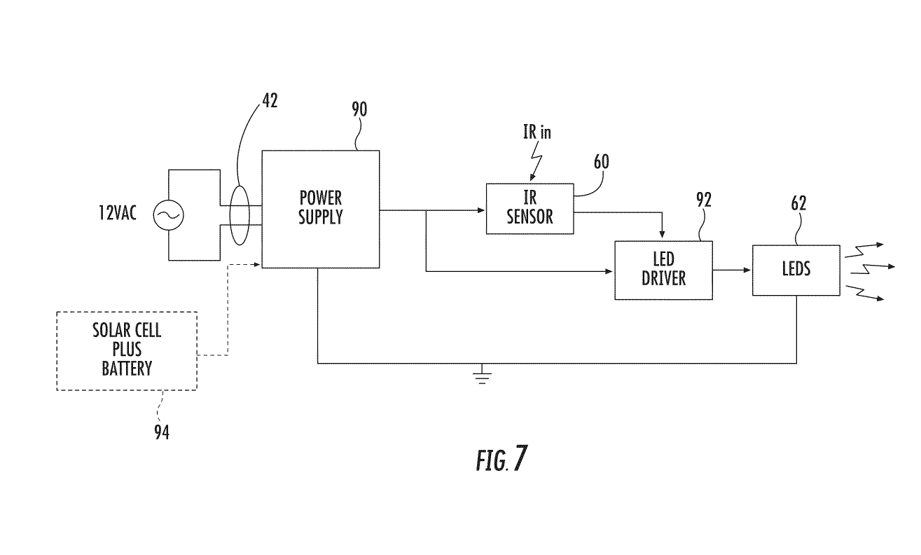

As noted above, the assembled lighting fixture 10 can be controlled by remote control 50. As shown in FIG. 6, the remote control 50 may use a line-of-sight signal, such that it must be pointed at the infrared sensor 60 and have an unimpeded path for communication. In this embodiment, the fixture body 12, guard 14, and cowl 18 are preferably opaque to prevent a control signal from passing through, and instead only allowing the control signal to travel directly through the lens 16 and optical assembly 44. As such, the user can control the lighting fixture 10 by aiming the remote control 50 at the lens 16 of the lighting fixture 10, but control signals will not travel through the rest of the lighting fixture 10. Alternatively, the lighting fixture 10 may include a transparent or translucent window, for example, in the side of the fixture body 12, through which an infrared signal may be transmitted, (Such a window 87 is shown in broken lines in FIG. 1 to illustrate this as an optional feature.) It will be appreciated that the lighting fixture 10 and remote control 50 allow for independent control of each fixture in a landscape lighting system, without concern that other lighting fixtures will be inadvertently controlled at the same time. In a preferred embodiment, the user can turn each light on or off independently, or adjust the lighting at fixed lighting increments with the push of a corresponding button (e.g., button 52). For example, the user can use the remote to set the lighting intensity at 10%, 20%, 40%, or 80% of the full lighting level.

Independent control of each lighting fixture in a system is ideal, for example, in situations where a homeowner is having guests and wants to adjust the lighting along a walkway toward the house. Also, depending on the seasons, the homeowner may want to highlight different features of the property. For example, it may be desirable to illuminate trees and shrubs in the spring when they are green and healthy-looking. However, when they are barren in the winter, the property's hardscapes or aesthetic structures could be highlighted instead.

Referring now to FIG. 7, various aspects of the circuitry contained on board 40 are illustrated. As be seen, low-voltage AC power from the transformer is received at receptacle 42. The AC power is converted to DC at the appropriate voltage level via a power supply 90. IR sensor 60 receives control signals from the handheld remote, which are used to direct operation of LED driver circuitry 92. Driver circuitry, in turn, controls the operation of the light source, in this case a plurality of individual LEDs. An alternative power source utilizing a solar cell plus battery arrangement is illustrated at 94 that can be used in addition to or in lieu of the AC voltage source in accordance with some embodiments of the invention.

While one or more example embodiments of the invention have been described above, it should be understood that any and all equivalent realizations of the present invention are included within the scope and spirit thereof. The embodiments depicted are presented by way of example only and are not intended as limitations upon the present invention as further described in the appended claims. Thus, it should be understood by those of ordinary skill in this art that the present invention is not limited to these embodiments since modifications can be made. In addition, it should be understood that aspects of the various embodiments may be interchanged both in whole or in part. Therefore, it is contemplated that any and all such embodiments are included in the present invention as may fall within the scope and spirit thereof.

1. A landscape lighting fixture for outdoor illumination, comprising:
a fixture body;
a control board including a light source and a sensor chip;
a protective lens; and
a guard,
wherein the fixture body, the guard, and the protective lens form a housing for the control board, and wherein the light source is controlled by a wireless control signal received by the sensor chip.

2. The landscape lighting fixture of claim 1, wherein the light source comprises a plurality of light-emitting diodes (LEDs).

3. The landscape lighting fixture of claim 2, wherein the light source comprises at least six LEDs.

4. The landscape lighting fixture of claim 1, further comprising a handheld remote, wherein the handheld remote is operative to send the wireless control signal to the sensor chip using optical communication.

5. The landscape lighting fixture of claim 4, wherein the handheld remote has a plurality of buttons corresponding to respective lighting intensity levels.

6. The landscape lighting fixture of claim 4, wherein the fixture body and the guard are opaque to optical communications from the handheld remote.

7. The landscape lighting fixture of claim 1, further comprising an optical assembly juxtaposed to the control board for diffusing the light source.

8. The landscape lighting fixture of claim 1, wherein the fixture body comprises a transparent window through which the control signal may be transmitted to the sensor chip.

9. The landscape lighting fixture of claim 1, further comprising a battery and a solar panel, wherein the solar panel generates electrical energy which is stored in the battery and is used to operate the landscape lighting fixture.

10. A lighting fixture for outdoor illumination, comprising:
a housing with a transparent lens;
a light source; and
an infrared sensor configured to control the light source based on infrared control signals,
wherein the infrared sensor is placed within the housing such that the infrared sensor only receives the infrared controls signals directed through the transparent lens.

11. The lighting fixture of claim 10, wherein the light source comprises a plurality of light-emitting diodes (LEDs).

12. The lighting fixture of claim 11, wherein the light source comprises at least six LEDs.

13. The lighting fixture of claim 10, further comprising a handheld remote, wherein the handheld remote is operative to send the infrared control signals to the infrared sensor.

14. The lighting fixture of claim 13, wherein the housing is opaque to the infrared control signals from the handheld remote.

15. The lighting fixture of claim 11, further comprising an optical assembly placed between the light source and the transparent lens for diffusing light from the light source.

16. The lighting fixture of claim 10, wherein the housing comprises a transparent window through which the infrared control signals may be transmitted to the infrared sensor.

17. The lighting fixture of claim 10, wherein the light source and the infrared sensor are disposed on a control board and are operatively connected by control circuitry.

18. The lighting fixture of claim 10, further comprising an energy storage device which is used to power the lighting fixture.

19. The lighting fixture of claim 18, further comprising a solar cell array which generates electrical energy that is used to charge the energy storage device.

20. A method for controlling a landscape lighting fixture, comprising:
receiving an infrared control signal from a remote through a protective lens of the lighting fixture; and
using control circuitry to operate a plurality of light-emitting diodes (LEDs) in accordance with the infrared control signal.

21. The method of claim 20, further comprising the step of transmitting light from the plurality of LEDs through an optical assembly such that the lights appear to be one light source.
